(19) United States
(12) Patent Application Publication
(10) Pub. No.: US 2015/0219519 A1
(43) Pub. Date: Aug. 6, 2015

(54) LEAK LOCATOR, SYSTEM AND METHOD OF USE

(71) Applicant: AIREVEAL LLC, HOLLYWOOD, FL (US)

(72) Inventors: GEORGE FETKO, DEERFIELD BEACH, FL (US); YAIR SHALEV, HOLLYWOOD, FL (US); ALEXANDER DEISER, BOCA RATON, FL (US)

(73) Assignee: AIREVEAL LLC, HOLLYWOOD, FL (US)

(21) Appl. No.: 14/173,376

(22) Filed: Feb. 5, 2014

(51) Int. Cl. G01M 3/06; B29C 73/10; B29D 30/06; B29C 73/24; G01M 17/02; B29C 73/00

(52) U.S. Cl. CPC G01M 3/06; G01M 17/02; B29C 73/00; B29D 30/0685; B29C 73/24; B29C 73/10

(57) ABSTRACT

A leak locator, system and method is light-weight, portable, and can be used to locate a leak in a closed environment, including tires, pipes, inflatables and other closed air/fluid filed structures, in situ. The leak locator includes an applicator and a leak locating/detecting liquid. The applicator includes a portion that is moistened and/or saturated by the leak detecting liquid, which portion is used to wipe or brush a film of the liquid onto a surface to be checked. The leak detecting liquid is formulated to cause bubbles to be formed in the film on the surface to be checked as a consequence of air or another fluid escaping from a leak in the surface.

### BACKGROUND OF THE INVENTION

1. Field of the Invention

The present invention relates to a leak locator, system and method of use and, more particularly, to a portable leak locator that can be easily used, in situ, to easily locate a leak in a tire or other closed environment.

2. Description of the Related Art

Various methods of locating a leak in a tire are known. For example, it is known to remove a tire from a vehicle or conveyance and place it in a trough of water, so as to locate the leak through the detection of air bubbles.

Additionally, U.S. Pat. No. 5,170,658 to Thayer discloses a portable bicycle tire leak detector apparatus which is adapted to be attachable to a bicycle frame or conventional bicycle tire pump. The apparatus of Thayer includes a water bottle having a trough member releasably mounted thereto. The trough member is adapted to contain a quantity of water in a manner allowing an inner-tube of a bicycle tire to be submerged in the trough member. See, for example, FIG. 1 (e.g. FIG. 5 of Thayer).

What is needed is a leak locator, system and method for detecting a tire leak that is light-weight, portable and which does not require the inner tube of the tire to be removed and submerged into a trough of water.

### SUMMARY OF THE INVENTION

The present invention satisfies the needs set forth above and, in particular, provides a leak locator, system and method that is light-weight, portable and which does not require submersion into a trough of water. More particularly, a leak locator, system and method are provided that can be used to locate a leak in a closed environment, including tires, pipes, inflatables and other closed air/fluid filed structures, in situ. In one particular embodiment, the leak locator is provided in the form of a kit that includes an applicator and a leak locating/detecting liquid. The applicator includes a portion that is moistened and/or saturated by the leak detecting liquid, which portion is used to wipe or brush a film of the liquid onto a surface to be checked. The leak detecting liquid is formulated to make bubbles to be formed in the film on the surface to be checked as a consequence of air or another fluid escaping from a leak in the surface.

Other features, which are considered as characteristic for the invention, are set forth in the drawings and the appended claims.

Although the invention is illustrated and described herein as embodied in a leak locator, system and method of use, it is nevertheless not intended to be limited to the details shown, since various modifications and structural changes may be made therein without departing from the spirit of the invention and within the scope and range of equivalents of the claims.

The construction of the invention, together with additional objects and advantages thereof, will be best understood from the following description of the specific embodiment when read in connection with the accompanying drawings.

### BRIEF DESCRIPTION OF THE DRAWINGS

For a fuller understanding of the nature of the present invention reference should be made to the following detailed description taken in connection with the accompanying drawings in which:

FIG. 1 is a partial perspective view of a portable leak locator for a bicycle tire in accordance with the prior art.

FIG. 2 is a perspective view of a leak detector in accordance with one particular embodiment of the present invention.

FIG. 3 is an exemplary illustration useful in describing a method for locating a leak in accordance with one particular embodiment of the present invention.

FIG. 4 is a perspective view of a leak detector in accordance with another particular embodiment of the present invention.

FIG. 5 is a perspective view of a leak detector in accordance with still another particular embodiment of the present invention.

FIG. 6 is a perspective view of a leak detector in accordance with still another particular embodiment of the present invention.

FIG. 6A is a perspective view of a trough that can be used with a leak detector in accordance with one particular embodiment of the present invention.

FIG. 6B is a side plan view of a spray bottle that can be used with a leak detector in accordance with one particular embodiment of the present invention.

FIGS. 7A and 7B illustrate dispenser-containers for holding and dispensing pre-moistened towels in accordance with one particular embodiment of the present invention.

FIGS. 8A, 8B and 8C are perspective views of leak detectors in accordance with further particular embodiments of the present invention.

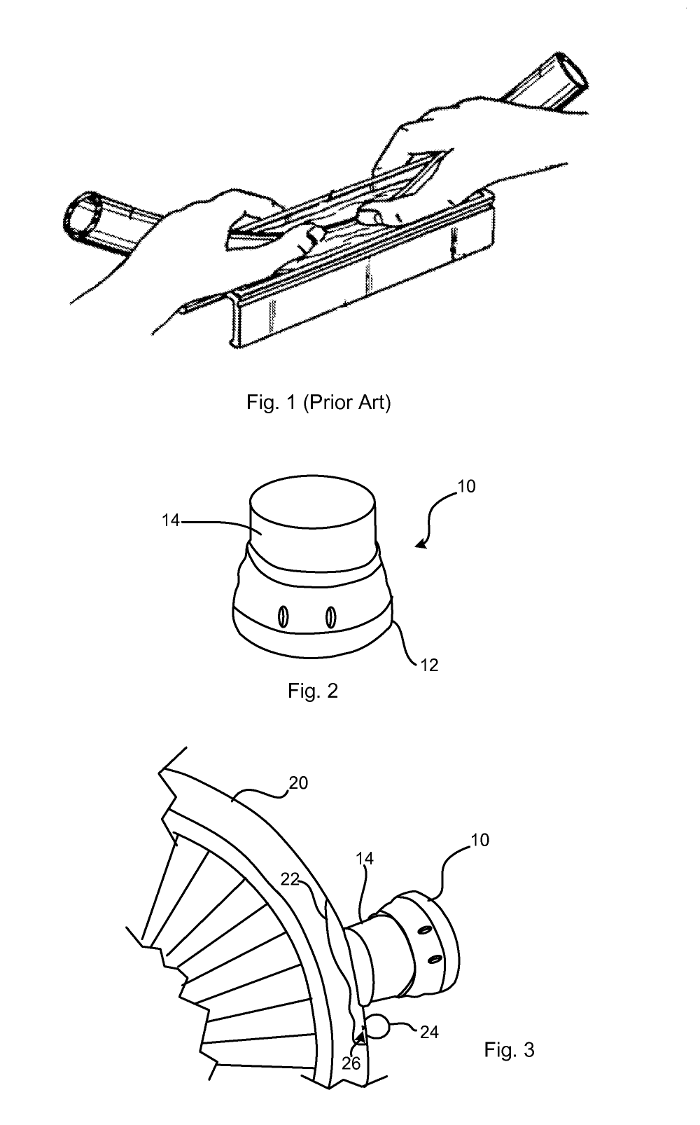

### DETAILED DESCRIPTION OF THE PREFERRED EMBODIMENT

A leak locator, system and method are provided that enables the detection of the location of a leak without having to remove a tire from the rim or wheel. Although the present particular invention will be described in connection with a bicycle tire having an inner tube, it should be understood that the present invention can be adapted for use in other applications in which air or other fluid is entrapped in a closed environment or “envelope” (e.g., tubeless tired, car/truck tired, fluid carrying piped, air mattresses, inflatable boats or rafts, etc) without departing from the scope or spirit of the present invention. Additionally, it should be noted that the term “leak”, as used herein, encompasses any opening, loose seal/joint, or puncture that permits the air or other fluid to escape from the envelope (inner tube and/or tire, in the present example), and “puncture”, as used herein, encompasses all types of perforations, cuts, holes or wounds to the tire that cause it to lose air.

Referring now to FIG. 2, there is shown a leak locator in accordance with one particular embodiment of the present invention. More particularly, an applicator 10 is provided having a handle 12 and a sponge 14. The applicator 10 is used to apply a liquid to the surface of the tire or other fluid envelope to be checked. More particularly, a user holds the handle portion 12, while wiping the upper surface of the sponge 14 over the surface to be checked, thus depositing the liquid on the surface to be checked. Bubbling of the liquid will occur at the location of a leak, thus indicating to the user where a patch is to be applied.

In one particular embodiment of the present invention, the liquid is formulated to leave a film on the surface, as a sponge containing the liquid is wiped over the surface. In one particularly preferred embodiment of the invention, a liquid or bubbling solution is formulated including water, a surfactant and glycerin (hereafter, the “glycerin solution”). For example, a solution including water, dish soap (or detergent) and glycerin can be used. In one particular embodiment of the invention, the leak detecting liquid consists of only water, a surfactant, glycerin and trace impurities. The use of glycerin in combination with the dish soap solution is highly advantageous in that bubbles generated from regular soapy water normally do not last very long. The addition of glycerin will make the bubbles much larger and last longer than a solution of dish soap alone. Consequently, once applied to the surface to be checked, for example, by brushing or wiping onto the surface with a sponge saturated with the glycerin solution, easily visible bubbles will form immediately at the leak sites, due to residual air or fluid released from those sites.

More particularly, referring back to FIG. 2, the sponge of the applicator 10 can be saturated with a leak detecting solution (such as the glycerin solution, described above) by dipping into cup or trough of the solution. Alternately, the handle 12 of the applicator 10 can include a reservoir, not shown, which can be filled with the leak detecting solution. In such a case, holes or a fluid-permeable membrane may be provided at the interface between the sponge 14 and handle 12 to permit the solution from the handle 12 to saturate the sponge 14 when the applicator is inverted (i.e., the handle 12 is held above the sponge 14. Alternately, if desired, a pump mechanism (not shown) can be incorporated into the handle 12 to pump liquid from a reservoir in the handle 10 into the sponge 14.

Referring now to FIGS. 2-3, the applicator 10 can be used to locate a leak site 26 in a tire 20 or other environment filed with air or another fluid, in situ. First, the sponge 14 of the applicator 10 is moistened with a bubbling solution as discussed herein. In one particular embodiment, the liquid solution is a glycerin solution including water, a surfactant such as dish soap, and glycerin. The moistened sponge 14 is wiped over the surface to be checked, i.e., the surface of the tire 20 to deposit a film 22 of the leak locating/bubbling solution on the surface. A leak 26 in the tire (and in the inner tube underlying the tire, if present) will cause a bubble 24 to form in the film 22, due to air or fluid escaping from the leak site 26. If desired, the tire 20 can be partially inflated prior to or during the application of the film 22, to ensure the presence of air or fluid in the tire which can escape from the leak site 26 to form the bubbles 24 in the film 22.

Additionally, in one particular embodiment of the invention, the leak locator of the present invention is packaged with, or as part of, a leak repair kit. Consequently, once the leak site(s) is/are located by visually finding the portions of the applied film that have bubbles, the method can further include using the kit to repair the leak. In one particular embodiment of the invention in which the surface to be checked is a tire, the leak locator of the present invention is provided as part of a tire repair kit and, after the leaks are located by visually detecting the bubbles in the film, the tire repair kit is used to repair the tire, in situ. In one particular embodiment of the invention, a patch is placed on, in or over the leak site. In another particular embodiment of the invention, the leak locator is provided as part of a patch kit as described in connection with co-pending U.S. patent application Ser. No. 14/092,404, filed on Nov. 27, 2013 and entitled “Tire Repair Tool, System and Method of Use”.

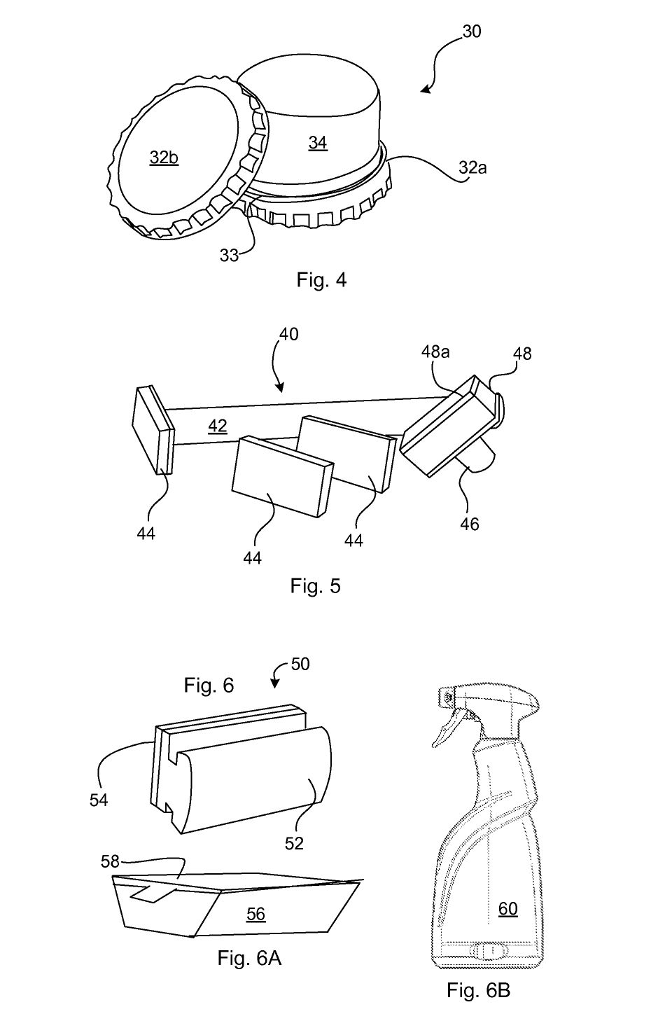

Although shown in connection with the applicator 10, it is important to note that other applicators can be used to apply the film 22 to the surface to be checked without departing from the scope or spirit of the present invention. For example, referring now to FIG. 4, there is shown another embodiment of an applicator 30 that can be used with the present invention. The applicator 30 includes a re-closeable housing formed from a lower handle portion 32a that matingly engages a cover portion 32b to enclose a pre-moistened sponge 34 therebetween. The housing portions 32a, 32b can screw together using a mating thread 33 or another type of mechanism, such as snap portions. It should be understood that the applicator 30 can be used to perform the method described in connection with FIG. 3.

Referring now to FIGS. 5-7, there is shown another example of an applicator 40 that can be used as the leak locator of the present invention. More particularly, the applicator 40 includes a handle 42 and a removable sponge 44. In one particular embodiment, the sponge 44 is mounted on a cylindrical sleeve (such as 46), so as to mate with a tubular recess in the handle 42. The handle 42 may have a reservoir for the leak detection liquid or the sponge 44 may be dipped into a cup of the solution, as desired. In one particular embodiment, the applicator 40 is sold as part of a kit having multiple replaceable sponge heads 44 to permit multiple uses of the applicator 40. If desired, in the present embodiment or in any other embodiment described herein, the sponge can includes both a sponge portion 48, and a shaped contact portion 48a for applying the liquid to the surface to be checked.

Similarly, if desired, a kit may be provided including an applicator as described U.S. Pat. No. 6,010,268 to Sereg et al (“Sereg”), that application being incorporated by reference herein in its entirety. In use, the handle component 12 of Sereg can be filled with a leak detecting liquid, such as the glycerin and soap solution described hereinabove, and such solution can be spread over the surface of a tire or other surface by wiping the surface of the sponge over the surface, in order to apply a thin film of the solution to the surface of the tire. As described above, air or fluid escaping from a puncture or leak in the tire will cause bubbles to be generated in the film overlaying the leak or puncture, and thus will allow the leak or puncture to be easily located. Other types of liquid dispensing applicators can additionally be used. See, for example, U.S. Pat. No. 2,947,015 to Burt, incorporated herein by reference.

In a further embodiment of the invention shown in FIGS. 6-6B, a foam applicator 50 is provided having a shaped handle portion 52 and a spongy portion 54 at a surface thereof. The spongy portion 54 is saturated with a liquid solution, such as the glycerin solution, and applied as described in connection with FIG. 3. In one particular embodiment of the invention, the spongy portion 54 is saturated by dipping it into a trough 56 filled with the solution, after the wrapper 58 has been removed sealing the trough 56. Alternately, a spray bottle 60, filled with the leak detection liquid solution can be provided to saturate the spongy portion 54 by spraying the liquid thereon. If desired, the spray bottle 60 can be used to spray the liquid directly on the surface to be checked, and the applicator would then be used to spread the liquid around the surface to ensure that the film is uniformly applied.

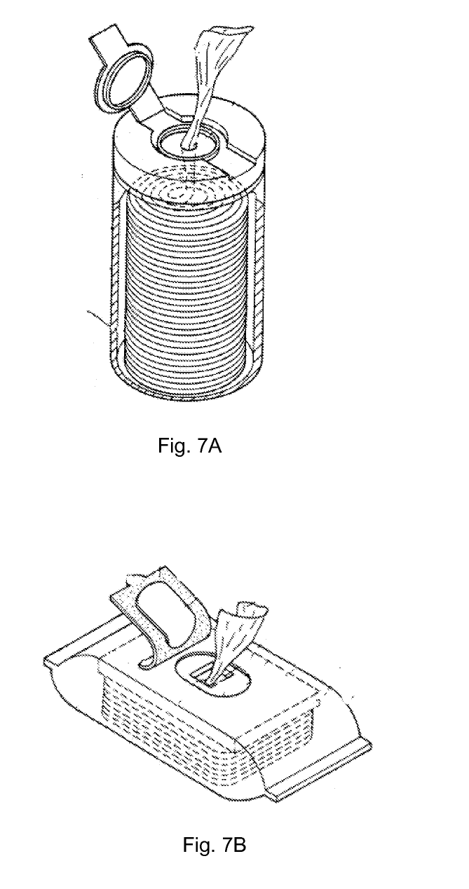

If desired, the applicator can be a disposable towel pre-moistened with the leak detection liquid. Such a pre-moistened towel can be provided in a cylinder, box or bag as described in U.S. Pat. No. 5,076,424 to Nakamura, which is incorporated herein, by reference. FIGS. 7A and 7B show two such dispensers that may be used to carry towels pre-moistened with a leak detecting liquid, such as the glycerin solution, for use in a method of the present invention. In such a method, the towel would be held directly and wiped onto the surface to be checked in order to apply the liquid film. The leak site would be detected from the bubbles formed in the liquid film applied. If desired, the towel or towelette dispensed can also include a spongy surface on one side to enable a better saturation of the towel or towelette and to ensure a uniform application of the liquid film to the surface to be checked.

Additionally, if desired, pre-moistened towels can be provided as individually wrapped and/or packaged wipes saturated with the leak detecting liquid. For example, the pre-moistened towel can be provided in a foil packet that is torn to access the towel.

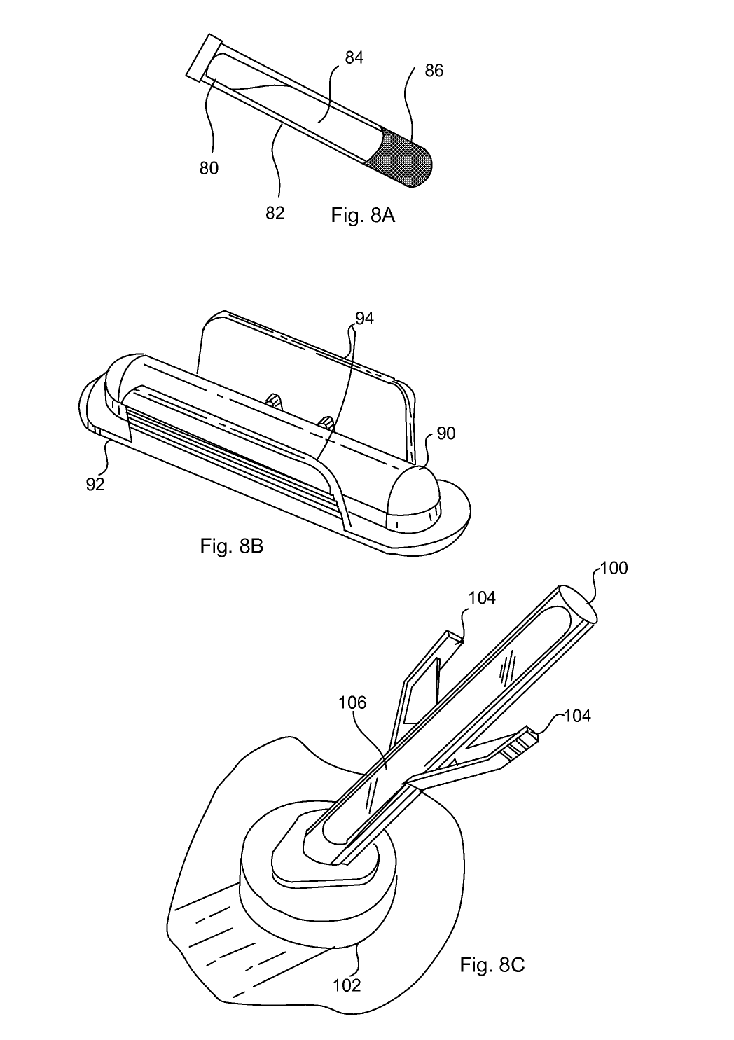

Even other types of applicators may be used with the present invention without departing from the scope or spirit of the present invention. For example, in one particular embodiment of the invention, the leak detecting liquid, such as the glycerin solution described herein, is provided in a frangible tube which is broken in order to release the liquid into a swab, sponge or towel for use in applying the liquid film to a surface to be checked. In one particular embodiment of the invention shown in FIG. 8A, a frangible glass tube 80 is provided within a flexible tube 82. The tube 80 is filed with a leak detection liquid 84 described herein. Outside the outer flexible tube 82, and in fluid communication with an inner chamber thereof, is a spongy or cotton swab portion 86. In use, the flexible tube 82 is pinched or squeezed in order to fracture the glass tube or inner vial 80 holding the liquid 84. Fracturing the inner vial 80 releases the liquid 84 into a chamber of the outer vial 82, wherein the liquid passes to, and saturates, the swab 86. The swab 86 is, in turn, used to wipe the surface to be checked in accordance with the description given in connection with FIG. 3, herein.

Referring now to FIG. 8B, there is shown another liquid applicator that can be used in connection with the leak locator of the present invention. More particularly, a liquid applicator 90 is provided for applying a desired liquid to a surface. The liquid applicator includes a closed vial formed of a fracturable material containing a leak detecting liquid, disposed in fluid communication with a sponge material 92. Protruding flange portions including wing-like gripping members 94 are used to fracture the vial and saturate the sponge material 92, as described in U.S. Pat. No. 5,538,353, incorporated herein by reference in its entirety. See also, for example, the applicator disclosed in U.S. Pat. No. 5,690,958 and in U. S. Patent Application Publication No. 2006/0072959, both of those references additionally being incorporated herein by reference in their entireties. After fracturing the inner vial, the saturated sponge material 92 is used to wipe the surface to be checked in accordance with the description given in connection with FIG. 3, herein.

Referring now to FIG. 8C, there is shown still another liquid applicator that can be used in connection with the leak locator of the present invention. More particularly, a liquid applicator 100 is provided for applying a desired liquid to a surface. The liquid applicator includes a closed vial formed of a fracturable material containing a leak detecting liquid, disposed in fluid communication with a sponge material 102. Protruding flange portions including diametrically opposed wings 104 projecting from a body thereof for fracturing the vial and saturate the sponge material 102, as described in U.S. Pat. No. 6,536,975, incorporated herein by reference in its entirety. After fracturing the inner vial, the saturated sponge material 102 is used to wipe the surface to be checked in accordance with the description given in connection with FIG. 3, herein.

Please note that the foregoing is provided for example, and is not meant to limit the invention only thereto, as other applicators and leak detecting liquids can be used without departing from the spirit and scope of the present invention. From the foregoing, it can be seen that the present invention provides a convenient, portable leak locator that saves time and money. The present invention eliminates the inconveniences of the prior art, including removal and reinstallation of the tire. Rather, the leak locator of the present invention is light-weight, portable, and self-contained, and can be used, in situ, on a tire that is still installed on the vehicle.

Although described herein in connection with the particular example of a tire for a bicycle or other vehicle, this is not meant to be limiting, as it can be seen how the leak locator, system and method of the present invention can be used in other applications without departing from the scope or spirit of the present invention, including, but not limited to, any kind of pipe, inflatable boat or mattress, or any other environment where air or fluid is passed into a closed environment. Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

I claim:

1. A method of locating a leak in a closed environment, comprising the steps of:
providing a leak locator including a spongy portion;
moistening the sponge portion with a leak detecting liquid including water, a surfactant and glycerin;
wiping the moistened spongy portion on a surface of the closed environment to form a film on the surface;
locating the leaks through the surface of the closed environment by visually detecting bubbles in the film.

2. The method of claim 1, wherein the surfactant is dish soap or detergent.

3. The method of claim 1, wherein the closed environment is a tire.

4. The method of claim 3, wherein the tire has an inner tube therein and wherein the method is performed without removing the tire from the vehicle.

5. The method of claim 3, wherein the providing step includes providing the leak locator as part of a tire repair kit.

6. The method of claim 5, wherein, after the locating step, the method further includes the step of repairing the tire using elements of the tire repair kit.

7. The method of claim 4, further comprising the step of only partially inflating the tire prior to or during the wiping step.

8. The method of claim 1, wherein the moistening step includes saturating the sponge portion with the leak detecting liquid.

9. A method of repairing a leak in a bicycle tire, comprising the steps of:
providing a leak locator including a spongy portion;
moistening the spongy portion with a leak detecting liquid;
wiping the moistened spongy portion on a surface of the closed environment to form a film on the surface;
locating the leaks through the surface of the tire by visually detecting bubbles in the film; and;
repairing the leaks in the tire.

10. The method of claim 9, wherein the leak detecting liquid includes water, a surfactant and glycerin.

11. The method of claim 10, wherein the surfactant is dish soap or detergent.

12. The method of claim 9, wherein the tire has an inner tube therein and wherein the method is performed without removing the tire from the vehicle.

13. The method of claim 9, wherein the providing step includes providing the leak locator as part of a tire repair kit.

14. The method of claim 9, further comprising the step of only partially reinflating the tire prior to or during the wiping step.

15. A tire repair kit, including:
an applicator including a sponge portion; and
a leak detecting liquid formulated to leave a film on a surface, which film forms bubbles
as a result of a fluid passing through said film.
at least one tire patch; and
tire adhesive.

16. The tire repair kit of claim 15, wherein the leak detecting liquid includes water, a surfactant and glycerin.

17. The tire repair kit of claim 16, wherein the surfactant is dish soap or detergent.

18. The tire repair kit of claim 15, wherein the leak detecting liquid is provided in a reservoir of said applicator.

19. The tire repair kit of claim 18, wherein said reservoir is a frangible tube in a chamber of said applicator, said chamber in fluid communication with said sponge material.

20. The tire repair kit of claim 15, wherein said applicator is a fabric towel or towelette.
